(19) United States
(12) Patent Application Publication
(10) Pub. No.: US 2025/0202031 A1
(43) Pub. Date: Jun. 19, 2025

(54) Battery Cell Having a Rupture Membrane

(71) Applicant: Bayerische Motoren Werke Aktiengesellschaft, Muenchen (DE)

(72) Inventors: Patrick OSSWALD, Muenchen (DE); Alexander RHEINFELD, Muenchen (DE); Robin RUECKER, Schaeftlarn (DE); Andreas SCHLEICHER, Erdweg (DE)

(21) Appl. No.: 18/846,897

(22) PCT Filed: Feb. 22, 2023
(86) PCT No.: PCT/EP2023/054466

§ 371 Date: Sep. 13, 2024

(30) Foreign Application Priority Data
Mar. 16, 2022 (DE) 10 2022 106 076.4

(51) Int. Cl. H01M 50/342; C06B 33/00; H01M 50/103; H01M 50/107; H01M 50/375; H01M 50/383

(52) U.S. Cl. CPC H01M 50/3425; C06B 33/00; H01M 50/103; H01M 50/107; H01M 50/375; H01M 50/383; H01M 2200/10; H01M 2200/20

(57) ABSTRACT

A battery cell including a battery cell casing having a rupture membrane, an electrode unit disposed in the battery cell casing, and an ignitable material that is disposed in a region of the rupture membrane and is configured to ignite and thereby open the rupture membrane on overheating of the battery cell casing and/or of the battery cell is provided. A battery module including a plurality of battery cells is further provided.

### BACKGROUND AND SUMMARY

The present disclosure relates to a battery cell having a battery cell casing comprising a rupture membrane, more particularly to a battery cell for a high-voltage battery.

Electrically powered motor vehicles such as electric vehicles, hybrid vehicles or plug-in-hybrid vehicles employ high-voltage batteries which typically comprise one or more battery modules each with a plurality of battery cells. Owing to the high energy density achievable, motor vehicles especially employ lithium-ion battery cells. Here and hereinbelow, the term “lithium-ion battery cell” is used synonymously for all designations commonplace in the prior art for lithium-containing galvanic elements and cells-for example, lithium battery, lithium cell, lithium-ion cell, lithium polymer cell, and lithium-ion accumulator. Rechargeable batteries (secondary batteries) are especially included. The terms “battery” and “electrochemical cell” are also used synonymously with the term “lithium-ion battery”. The lithium-ion battery cell may also be a solid-state battery-for example, a ceramic or polymer-based solid-state battery.

In the case of a mechanical impact onto the battery cell, brought about for example by deformation and/or by penetration of a sharp object into the battery cell, or on overcharging of the battery cell, there may be a risk of overheating of the battery cell. Exothermic electrode reactions, due for example to shorting of the electrodes, may result in thermal runaway of the battery cell. At high temperatures, there may in particular be evaporation of the electrolyte contained in the battery cell, causing a critical overpressure in the battery cell. In a battery module comprising a plurality of battery cells, the thermal runaway of one battery cell can lead to the overheating spreading to the adjacent battery cells, and so there may be a risk of damage to the entire battery module or even the entire high-voltage battery if this is not prevented by suitable safety measures.

Published specification DE 10 2015 014 343 A1 describes a cell holder for a battery cell, the holder, on one casing surface, comprising an opening featuring a rupture membrane for overpressure relief. A rupture membrane of this kind is intended to drain the gas caused by evaporation of the electrolyte, and thereby to relieve the overpressure in the battery cell without damage to adjacent battery cells.

It is an object of the present disclosure to specify an improved battery cell having a rupture membrane, being notable in particular for reliable opening of the rupture membrane when the battery cell is in a critical state.

This object is achieved by a battery cell according to claim 1. Advantageous embodiments and developments of the present disclosure are apparent from the dependent claims.

According to one embodiment, the battery cell comprises a battery cell casing having a rupture membrane. The battery cell casing may for example be a prismatic battery cell casing. Alternatively the battery cell casing may be a cylindrical battery cell casing; more particularly, the battery cell may be a round cell. The rupture membrane is provided as an outlet for gas in the event of the battery cell being in a critical state with regard to pressure and/or temperature. The rupture membrane may for example be a region of the battery cell casing in which the material of the battery cell casing is thinned, or in which a material is employed which bursts at a mandated pressure. The battery cell further comprises at least one electrode unit, embodied for example as an electrode roll (jelly roll) or electrode stack. The battery cell may more particularly be a lithium-ion battery cell.

With the battery cell, in the region of the rupture membrane, an ignitable material is disposed which is configured to ignite and thereby to open the rupture membrane on overheating of the battery cell casing and/or of the battery cell. The ignitable material may in particular be intended to ignite on exceedance of a critical temperature of the battery cell casing, so that the rupture membrane is reliably opened.

In a critical state of the battery cell, the opening of the rupture membrane that is achieved in this way allows electrolyte gas to escape from the battery cell, so making it possible to prevent an overpressure building up in the battery cell. As the escape of the electrolyte gas is an endothermic reaction, the cell temperature can be reduced as a result. Furthermore, the escape of the electrolyte results in an increase in the internal resistance of the battery cell. The risk of thermal runaway of the battery cell is diminished in this way. With a battery cell disposed in a battery module, accordingly, there is a diminished risk of the critical state of one battery cell spreading to adjacent cells of the battery module.

The present disclosure rests in particular on the following considerations: A rupture membrane of a battery cell casing is typically intended to burst when the pressure in the battery cell exceeds a critical pressure. A comparatively fragile design of the rupture membrane may on the one hand increase the certainty of the rupture membrane actually bursting when the battery cell is in a critical state. On the other hand, the critical pressure at which the rupture membrane bursts must not be too low, so that there is no risk of the rupture membrane bursting even during production of the battery cell or under conventional operating conditions. Furthermore, the rupture membrane is intended to ensure adequate sealing of the cell casing with respect to gases, especially oxygen, or moisture. A comparatively rigid and tight design of the rupture membrane would for its part increase the risk of the rupture membrane bursting only at a battery cell pressure at which the battery cell is already in a very critical state, resulting possibly in thermal runaway of the cell. With conventional rupture membranes, the problem may exist that the critical pressure at which the rupture membrane bursts can be set only with an accuracy of about ±2 bar, owing to manufacturing tolerances. The ignitable material which is disposed in the region of the rupture membrane in the battery cell described herein means that the rupture membrane is induced to burst at a critical temperature at which the ignitable material ignites. It is thereby possible to ensure that gases, more particularly the gas of an electrolyte which has already undergone at least partial evaporation, can escape from the battery cell casing already when the critical temperature is reached. In this way, an overpressure is prevented from building up in the cell. In other words, there is a temperature-triggered opening of the rupture membrane even before a significant increase in the internal pressure in the battery cell. This diminishes the risk of thermal runaway of the battery cell and so increases the safety.

According to one embodiment, the ignitable material is connected to at least one igniter cord which is coupled to the battery cell casing. The at least one igniter cord borders the battery cell casing directly, for example, and/or is mounted on the battery cell casing. The igniter cord is configured in particular to ignite on exceedance of a critical temperature of the battery cell casing. In this way, it can be ensured that the ignitable material is ignited if the temperature of the battery cell casing exceeds the critical temperature. This may be the case, for example, if, in a battery module, a further battery cell disposed next to the battery cell exceeds a critical temperature—for example, if the further battery cell suffers thermal runaway. In this way, thermal runaway in adjacent battery cells in the event of thermal runaway of one battery cell in a battery module is prevented. The safety of the battery module is thereby increased.

It is possible for the ignitable material to be connected to a plurality of igniter cords which border the battery cell casing at different points. In the case of a prismatic battery cell casing, for example, there may be a plurality of igniter cords disposed on a plurality of side faces. There is preferably at least one igniter cord disposed on each side face of the battery cell casing. An advantage of this is that the respective igniter cord ignites on overheating of one of the side faces. In a battery module, there is preferably an igniter cord disposed at least on each side face of the battery cell that borders an adjacent battery cell.

The critical temperature at which the igniter cord ignites is in particular between 90° C. inclusive and 120° C. inclusive. The critical temperature is preferably not more than 100° C., more preferably between 90° C. inclusive and 100° C. inclusive. The igniting of the ignitable material and the consequent opening of the rupture membrane within this temperature range make it possible advantageously to halt reactions which precede thermal runaway of the battery cell, more particularly the dissolution of the solid-electrolyte interface (“SEI”) or the decomposition of the electrolyte. In this way, the risk of thermal runaway of the battery cell can be advantageously diminished.

According to one embodiment, the igniter cord comprises at least regionally a thermally insulating jacket. The thermally insulating jacket is, for example, a glass fibre jacket. The thermally insulating jacket separates the igniter cord from, in particular, the electrode unit. This ensures that the ignition of the igniter cord does not lead to the electrode unit being set alight.

According to one embodiment, the ignitable material comprises a mixture comprising iron(III) oxide and aluminum. The iron(III) oxide and the aluminum in the mixture are present advantageously as powder or granules; the mixture more particularly is a flowable compound. Such a mixture is known by the designation “thermite”. Ignition of the mixture sets in train an exothermic reaction in which the

iron(III) oxide reacts with the aluminum to form iron and aluminum oxide (thermite reaction), with strong heat being given off.

The ignitable material is disposed at a distance from the rupture membrane such that the rupture membrane is opened by the exothermic reaction. The distance between the ignitable material and the rupture membrane is in particular less than 10 mm, preferably less than 5 mm or even less than 3 mm.

According to one embodiment, the ignitable material is separated from the electrode unit by a thermally insulating material. This ensures that the ignition of the ignitable material does not lead to the electrode unit being set alight. The thermally insulating material comprises glass or a ceramic, for example.

The battery cell described herein may in particular be a prismatic or a cylindrical battery cell. In the case of a prismatic battery cell, the battery cell casing may have a rectangular basal area and be substantially cuboid. Prismatic battery cells can advantageously be easily stacked and assembled to form a battery module. In the case of a cylindrical battery cell, also called a round cell, the battery cell has a circular basal area and is substantially cylindrical.

The battery cell casing may for example comprise a base, one or more side walls, and a lid. The rupture membrane is disposed for example on the lid of the battery cell casing. The electrical connections of the battery cell are routed for example out of the lid. The rupture membrane may for example be disposed between the electrical connections in the lid of the battery cell casing.

Further proposed are a battery module comprising a plurality of the battery cells described herein, and a motor vehicle comprising such a battery module. The battery cell described herein may, on account of improved safety, be used advantageously in a battery module that can be employed as a traction battery in an electrically powered motor vehicle.

A preferred exemplary embodiment of the present disclosure is described below with reference to the figures. Apparent therefrom are further details, preferred embodiments and developments of the present disclosure.

### BRIEF DESCRIPTION OF THE DRAWINGS

FIG. 1A shows schematically a view in section parallel to the longitudinal side of a battery cell according to one exemplary embodiment,

FIG. 1B shows schematically a plan view of the battery cell of FIG. 1A,

FIG. 1C shows schematically a view in section parallel to the transverse side of the battery cell of FIG. 1A,

FIG. 2 shows schematically a plan view of a battery module comprising a plurality of battery cells,

FIGS. 3A to 3C show the battery cell according to FIG. 1A respectively at different moments in the event of overheating of the battery cell casing.

### DETAILED DESCRIPTION OF THE DRAWINGS

Identical constituents or constituents identical in effect are each provided with the identical reference numerals in the figures. The constituents represented and also the proportions of the constituents among one another should not be regarded as being true to scale.

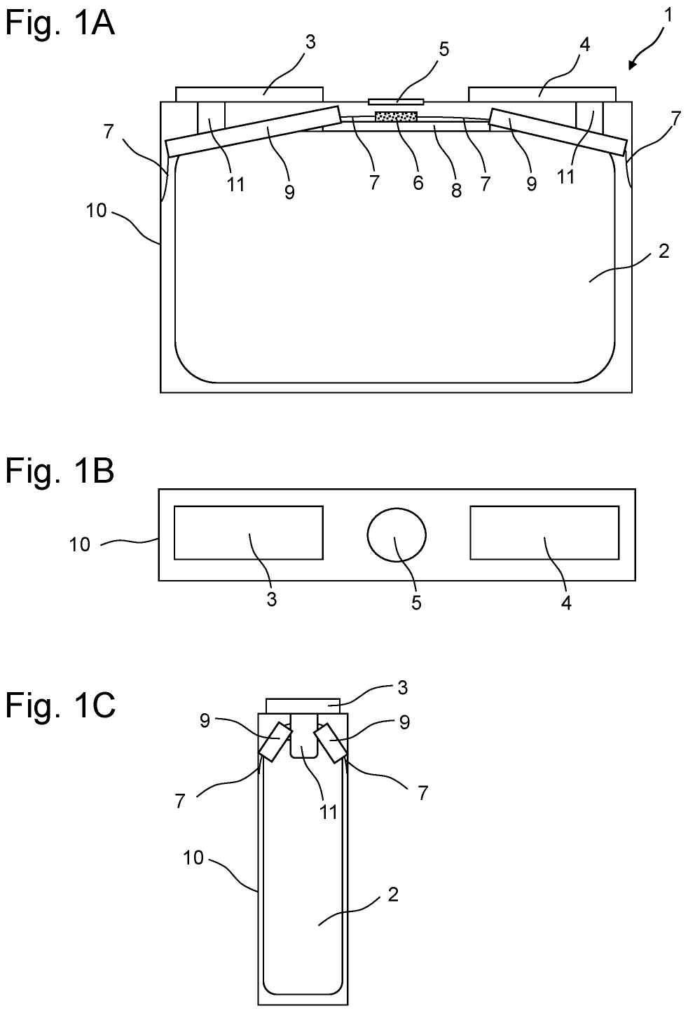

Represented in FIGS. 1A, 1B and 1C is an exemplary embodiment of a battery cell 1 in a section parallel to the longitudinal side, in a plan view, and in a section parallel to the transverse side. In the exemplary embodiment shown here, the battery cell 1 comprises a prismatic battery cell casing 10. In the exemplary embodiment, the battery cell casing 10 has a rectangular basal area and is substantially cuboid. The battery cell casing 10 forms a mechanically firm shell for an electrode unit 2, disposed therein, of the battery cell 1. The electrode unit 2 may take the form, for example, of an electrode stack or electrode roll. The battery cell casing 10 may be formed of a metal such as aluminum or steel, for example. It is possible for the battery cell casing 10 to comprise at least regionally an electrically insulating coating. The battery cell casing 10 has a first terminal 3 and a second terminal 4, which are disposed for example on a lid of the battery cell casing 10. The terminals 3, 4 are intended for the electrical contacting of the positive and negative electrodes of the electrode unit 2 of the battery cell 10. The terminals 3, 4 are each connected, for example, to the electrode unit 2 via electrical connections 11.

Also visible in FIG. 1 is a rupture membrane 5 which is disposed on the lid of the battery cell casing 10 and is disposed for example in the region between the terminals 3, 4. The rupture membrane 5 has a safety function during operation of the battery cell 1. On exceedance of a critical temperature, an electrolyte contained in the battery cell 1 may undergo at least partial evaporation. The rupture membrane 5 is intended more particularly to burst on exceedance of a critical pressure in the battery cell 1, allowing gas and/or fluid to escape from the battery cell 1. The gas and/or the fluid may more particularly be the electrolyte of the battery cell 1. The rupture membrane 5 comprises or consists of aluminum, for example. The rupture membrane 5 may for example be a region of the battery cell casing 10 in which the material of the battery cell casing 10 is thinned. The thickness of the rupture membrane 5 is preferably from 100 μm inclusive to 300 μm inclusive.

An ignitable material 6 is disposed in the battery cell 1, in the region of the rupture membrane 5. The ignitable material 6 is more particularly a compound of at least two different materials which are able to undergo strongly exothermic reaction with one another. The ignitable material is preferably a compound of iron oxide and aluminum, also known by the designation “thermite”. Ignition sets in train a strongly exothermic reaction, with the resultant heat and/or pressure causing the rupture membrane 5 to open. It is advantageous for this purpose if the ignitable material 6 is disposed at a small distance from the rupture membrane 5—for example, at a distance of less than 10 mm, less than 5 mm or even less than 3 mm. The ignitable material 6 is separated from the electrode unit 2 by a thermally insulating material 8. This diminishes the risk of the electrode unit 2 overheating or catching fire on ignition of the ignitable material 6. The thermally insulating material 8 may comprise glass or ceramic, for example.

The ignitable material 6 may be ignited by an igniter cord 7, which is routed from the ignitable material 6 to the battery cell casing 10 and is preferably mounted on the battery cell casing 10. It is possible for the battery cell casing 10 to comprise a plurality of igniter cords 7—for example, one igniter cord 7 on each of the four side faces of the battery cell casing 10. The igniter cords 7 are preferably routed to the ignitable material 6 both from the longitudinal sides and from the transverse sides of the battery cell casing. The at least one igniter cord 7 preferably comprises a material which ignites at a critical temperature in the range from about 90° C. to 120° C., as for example at about 100° C. The igniter cord 7 may be ignited by heating of the battery cell casing 10 if the temperature of the battery cell casing 10 exceeds the critical temperature. The igniter cord 7 is thermally insulated from the electrode unit 2. In particular, the igniter cord 7 may comprise at least regionally a thermally insulating jacket 9, which comprises glass, glass fibers or ceramic, for example. This diminishes the risk of the electrode unit 2 being set on fire by the ignition of the igniter cord 7.

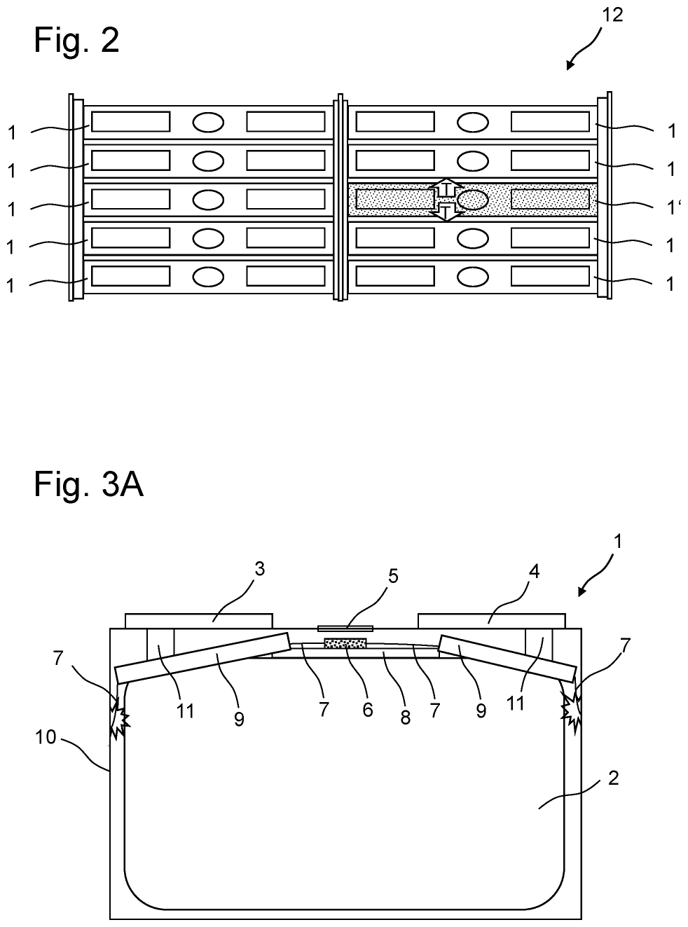

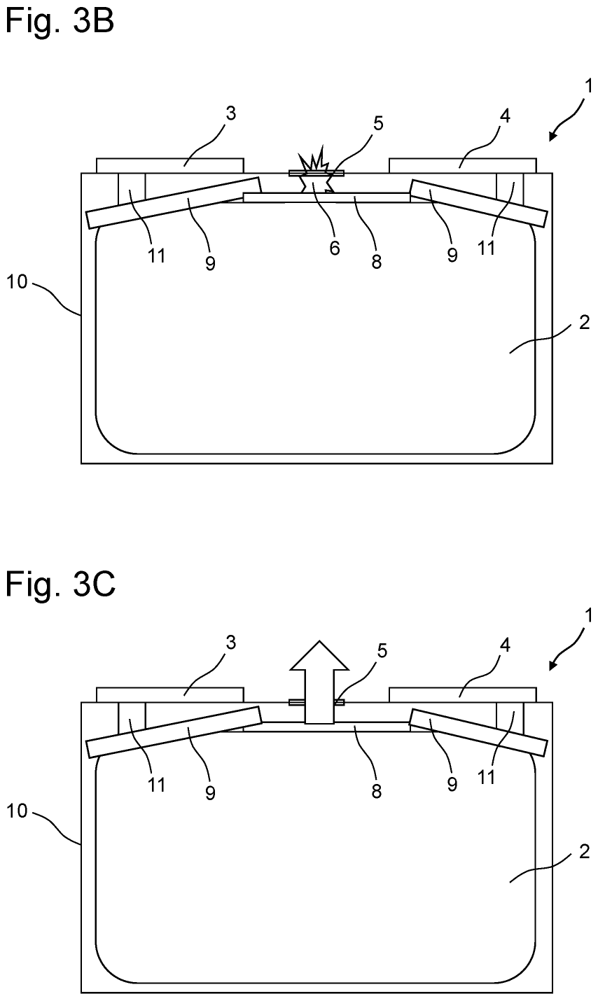

Shown schematically in FIG. 2 is a plan view of a battery module 12, comprising a plurality of battery cells 1, 1′. To simplify the representation, ten battery cells 1, 1′ are represented illustratively here, although there are no limitations on the number of the battery cells 1, 1′ in the battery module 12. It is additionally possible for the battery module 12 to comprise round cells, for example, instead of the prismatic battery cells 1, 1′ represented here. FIG. 2 represents the case of the overheating of a battery cell 1′ as a result, for example, of a defect in this battery cell 1′. For example, the overheated battery cell 1′ may be in a state of thermal runaway. The overheated battery cell 1′ may give off heat to adjacent battery cells 1, as symbolized by the arrows T. In this case, without suitable countermeasures, there may be a risk of the overheated battery cell 1′ giving off so much heat to the adjacent battery cells 1 that these battery cells 1 also suffer thermal runaway and that in this way a chain reaction is initiated in the battery module 12, accompanied by damage to the entire battery module 12. Such a chain reaction can be advantageously prevented in accordance with the principle proposed herein. This is illustrated more closely below with reference to FIGS. 3A to 3C.

FIG. 3A shows a battery cell 1 in cross section, the cell being embodied, for example, like the battery cell according to FIGS. 1A to 1C. If the battery cell casing 10 on which the at least one igniter cord 7 is mounted heats up to a critical temperature in this region, the igniter cord 7 is ignited. This may be the case, for example, when an adjacent battery cell overheats or even suffers thermal runaway.

After the igniter cord 7 has burned away, the ignitable material 6 is ignited (see FIG. 3B). This starts a reaction in which the ignitable material—a mixture of iron oxide and aluminum (thermite), for example—reacts exothermically. As a consequence of the heat and/or pressure produced in the exothermic reaction in the region of the rupture membrane 5, the rupture membrane 5 is opened (see FIG. 3C). The effect of this is that the rupture membrane 5 of the battery cell casing 10 is opened already when the battery cell casing 10 undergoes strong heating, more particularly to a critical temperature in the range from about 90° C. to 120° C. The critical temperature at which the igniter cord 7 is ignited may in particular be less than the temperature at which the battery cell 1 suffers thermal runaway. The temperature at which the battery cell 1 suffers thermal runaway may amount to 150° C. or more, for example. Because the rupture membrane 5 opens when the battery cell casing 10 has reached a critical temperature, hot gases are able to escape from the battery cell 1 even before the thermal runaway. In this way, the temperature in the battery cell 1 goes down and the internal resistance of the battery cell 1 increases as a result of the escape of the electrolyte. Consequently, the risk of thermal runaway of the battery cell 1 is diminished and accordingly the safety is increased.

Although the present disclosure has been illustrated and described in detail using exemplary embodiments, the present disclosure is not limited by the exemplary embodiments. On the contrary, different variations of the present disclosure may be derived therefrom by the skilled person without departing from the scope of protection of the present disclosure as defined by the claims.

### LIST OF REFERENCE NUMERALS

1 battery cell
1′ overheated battery cell
2 electrode unit
3 first terminal
4 second terminal
5 rupture membrane
6 ignitable material
7 igniter cord
8 thermally insulating material
9 thermally insulating jacket
10 battery cell casing
11 electrical connection
12 battery module

1-10. (canceled)

11. A battery cell comprising
a battery cell casing having a rupture membrane,
an electrode unit disposed in the battery cell casing, and
an ignitable material that is disposed in a region of the rupture membrane and is configured to ignite and thereby open the rupture membrane on overheating of the battery cell casing and/or of the battery cell.

12. The battery cell according to claim 11,
wherein the ignitable material is connected to at least one igniter cord that is coupled to the battery cell casing.

13. The battery cell according to claim 12,
wherein the igniter cord is configured to ignite on exceedance of a critical temperature of the battery cell casing.

14. The battery cell according to claim 13,
wherein the critical temperature is between 90° C. inclusive and 120° C. inclusive.

15. The battery cell according to claim 12,
wherein the igniter cord comprises a thermally insulating jacket.

16. The battery cell according to claim 15,
wherein the thermally insulating jacket is a glass fibre jacket.

17. The battery cell according to claim 11, wherein the ignitable material comprises a mixture comprising iron(III) oxide and aluminum (thermite).

18. The battery cell according to claim 11, wherein the ignitable material is disposed at a distance of not more than 10 mm from the rupture membrane.

19. The battery cell according to claim 11, wherein the ignitable material is separated from the electrode unit by a thermally insulating material.

20. The battery cell according to claim 11, wherein the battery cell is a prismatic battery cell or a round cell.

21. The battery cell according to claim 11, wherein the rupture membrane is a portion of the battery cell casing wherein a material of the battery cell casing is thinned.

22. The battery cell according to claim 21, wherein the rupture membrane has a thickness of from 100 μm to 300 μm.

23. A battery module comprising a plurality of battery cells according to claim 11.

24. The battery module of claim 23, wherein the battery module is configured such that on overheating of a first battery cell and/or a first battery cell casing thereof, a second battery cell and/or a second battery cell casing thereof is not overheated.
